(19) United States
(12) Patent Application Publication
(10) Pub. No.: US 2011/0282827 A1
(43) Pub. Date: Nov. 17, 2011

(54) CUSTOMIZABLE SPECIMEN EVALUATION

(75) Inventors: Kathleen H. Groover, Frederick, MD (US); Daniel Lewandowski, Frederick, MD (US); Louis M. Cosentino, Poolesville, MD (US)

(73) Assignees: THE UNITED STATES OF AMERICA, Bethesda, MD (US); FISHER BIOSERVICES INC., Rockville, MD (US)

(21) Appl. No.: 13/102,133

(22) Filed: May 6, 2011

Related U.S. Application Data
(60) Provisional application No. 61/333,900, filed on May 12, 2010.

(51) Int. Cl. G06N 5/02

(52) U.S. Cl. 706/54

(57) ABSTRACT

Embodiments of the invention provide a method and apparatus to evaluate at least one specimen for a predetermined purpose. The method comprises establishing at least one category that includes a plurality of criteria with which to evaluate the at least one specimen and receiving at least one scoring parameter that weights the at least one category. The method further comprises presenting at least some of the plurality of criteria to the user and calculating, based upon the scoring parameter as well as data entered by the user and associated with the presented criteria, a score for the at least one specimen.

The present application claims the filing benefit of U.S. Provisional Application Ser. No. 61/333,900, filed May 12, 2010, the disclosure of which is incorporated herein by reference in its entirety.

### FIELD OF THE INVENTION

The present invention relates generally to specimen management, and more particularly to a customizable specimen evaluation tool.

### BACKGROUND OF THE INVENTION

Collections of biospecimens are often critical to successful clinical research and in the fight against disease. In today's research environment, millions of specimens are collected and placed into storage. Concurrently, a tremendous amount of data concerning the acquisition, processing, analysis, and storage of the specimens is collected. However, over time the costs of establishing new collections and the maintenance of older collections often increase exponentially.

Thus, curators are often placed in situations that require the destruction or relocation of all or some of their respective collections. Curators are consequently tasked with questions as to whether to destroy a portion of a collection, and if so which portion? Then, curators are tasked with determining whether to transport those portions that aren't destroyed, and then to determine how to choose what to transfer versus those portions of a collection to remain.

Additionally, there are no industry standards concerning the acquisition of specimens, the processing of specimens, the quality of specimens, or the maintenance of specimens. This often leads to concerns with the maintenance of specimens from other collections that are incorporated into a curator's collection. Furthermore, such lack of standards also results in data incongruity between collections. For example, one collection may include specimens that are intended for a first type of study while another includes specimens that are intended for a second type of study. However, some specimens in the first collection may be able to be used in the second type of study. Without proper specimen and data maintenance, however, such cross-usage of samples may be rendered impossible.

### SUMMARY OF THE INVENTION

Embodiments of the invention address the drawbacks of the prior art and provide a method and apparatus to evaluate at least one specimen for a predetermined purpose. The method comprises establishing at least one category that includes a plurality of criteria with which to evaluate the at least one specimen and receiving at least one scoring parameter that weights the at least one category. The method further comprises presenting at least some of the plurality of criteria to the user and calculating, based upon the scoring parameter as well as data entered by the user and associated with the presented criteria, a score for the at least one specimen.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagrammatic illustration of a hardware and software environment for an computing system configured to evaluate at least one specimen consistent with embodiments of the invention;

FIG. 2 is an illustration of a general information screen that may be displayed by the computing system of FIG. 1;

FIG. 3 is an illustration of a global data screen that may be displayed by the computing system of FIG. 1;

FIG. 4 is an illustration of a study screen that may be displayed by the computing system of FIG. 1;

FIG. 5 is an illustration of a documentation screen that may be displayed by the computing system of FIG. 1;

FIG. 6 is an illustration of a storage screen that may be displayed by the computing system of FIG. 1;

FIG. 7 is an illustration of a data file screen that may be displayed by the computing system of FIG. 1;

FIG. 8 is an illustration of a legal and regulatory screen that may be displayed by the computing system of FIG. 1;

FIG. 9 is an illustration of a report screen that may be displayed by the computing system of FIG. 1;

FIG. 10 is a flowchart illustrating a sequence of operations executable by the computing system of FIG. 1 to configure data for an evaluation of at least one specimen;

FIG. 11 is a flowchart illustrating a sequence of operations executable by the computing system of FIG. 1 to implement an evaluation of at least one specimen.

It should be understood that the appended drawings are not necessarily to scale, presenting a somewhat simplified representation of various features illustrative of the basic principles of embodiments of the invention. The specific design features of embodiments of the invention as disclosed herein, including, for example, specific dimensions, orientations, locations, and shapes of various illustrated components, as well as specific sequences of operations (e.g., including concurrent and/or sequential operations), will be determined in part by the particular intended application and use environment. Certain features of the illustrated embodiments may have been enlarged or distorted relative to others to facilitate visualization and clear understanding.

### DETAILED DESCRIPTION OF THE INVENTION

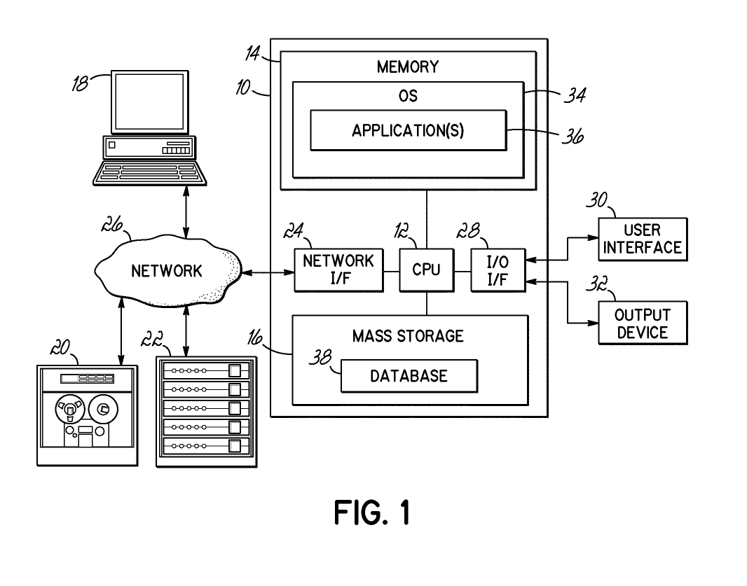

Turning to the drawings, wherein like numbers denote like parts throughout the several views, FIG. 1 is a diagrammatic illustration of a hardware and software environment for an apparatus 10 configured to evaluate at least one specimen consistent with embodiments of the invention. Apparatus 10, in specific embodiments, is a computer, computer system, computing device, server, disk array, or programmable device such as a multi-user computer, a single-user computer, a handheld computing device, a networked device (including a computer in a cluster configuration), a mobile telecommunications device, a video game console (or other gaming system), etc. Apparatus 10 may be referred to as “computing apparatus,” but will be referred to herein as “computing system.”

The computing system 10 includes at least one central processing unit (“CPU”) 12 coupled to a memory 14. Each CPU 12 is typically implemented in hardware using circuit logic disposed on one or more physical integrated circuit devices or chips. Each CPU 12 may be one or more microprocessors, micro-controllers, field programmable gate arrays, or ASICs, while memory 14 may include random access memory (RAM), dynamic random access memory (DRAM), static random access memory (SRAM), flash memory, and/or another digital storage medium, and also typically implemented using circuit logic disposed on one or more physical integrated circuit devices, or chips. As such, memory 14 may be considered to include memory storage physically located elsewhere in the computing system 10, e.g., any cache memory in the at least one CPU 12, as well as any storage capacity used as a virtual memory, e.g., as stored on a mass storage device 16, another computing system 18, a network storage device 20 (e.g., a tape drive), or another network device 22 (hereinafter, a “server” 22) coupled to computer 10 through at least one network interface 24 (illustrated as, and hereinafter, “network I/F” 24) by way of at least one network 26. It will be appreciated that the at least one network 26 may include at least one private communications network (e.g., such as an intranet) and/or at least one public communications network (e.g., such as the Internet). Similarly to the computing system 10, computing system 18 or server 22, in specific embodiments, is a computer, computer system, computing device, server, disk array, or programmable device such as a multi-user computer, a single-user computer, a handheld computing device, a networked device (including a computer in a cluster configuration), a mobile telecommunications device, a video game console (or other gaming system), etc.

The computing system 10 is coupled to at least one peripheral device through an input/output device interface 28 (illustrated as, and hereinafter, “I/O I/F” 28). In particular, the computing system 12 receives data from a user through at least one user interface 30 (including, for example, a keyboard, mouse, a microphone, and/or other user interface) and/or outputs data to the user through at least one output device 32 (including, for example, a display, speakers, a printer, and/or another output device). Moreover, in some embodiments, the I/O I/F 28 communicates with a device that is operative as a user interface 30 and output device 32 in combination, such as a touch screen display (not shown).

The computing system 10 is typically under the control of an operating system 34 and executes or otherwise relies upon various computer software applications, sequences of operations, components, programs, files, objects, modules, etc., consistent with embodiments of the invention. In specific embodiments, the computing system 10 executes or otherwise relies on an application 36 to evaluate at least one specimen (e.g., an “evaluation application”) consistent with embodiments of the invention. Moreover, and in specific embodiments, the computing system 10 is configured with a database 38 to store data about a collection, at least one specimen, and/or other data associated with an evaluation consistent with embodiments of the invention.

The evaluation application 36 is configured to evaluate specimen collections for a specific purpose, such as culling, robotics, research use, etc. Criteria related to that purpose are defined and categorized, then weighted by a user. The evaluation application 36 then determines a score for at least one specimen according to the categories, criteria, and/or weights assigned thereto. The score is then presented along with a report.

Specifically, the evaluation application 36 is configured to present a default and/or custom purpose for an evaluation, then present default categories of criteria based upon the selected purpose. Additionally and/or alternatively, the user can define custom categories for the evaluation application 36 to present for default and/or custom purposes. In any event, each category defines at least one criterion for the evaluation application 36. For example, each criteria may include textual queries or prompts, as well as check boxes, drop-down boxes, text entry boxes, selection boxes, and/or other user interface elements that capture data from the user.

In some embodiments, the evaluation application 36 captures general information associated with at least one specimen of a collection utilizing general information criteria. The general information criteria may capture data relating to the methods, populations, and scope of a collection of specimens, as well as the cost of the study, funding for the study, and other study information. In one embodiment, Table 1 indicates at least some general information criteria that may be utilized by the evaluation application 36. In particular, Table 1 indicates general information criteria that may be used for three different purposes.

TABLE 1
General Information Criteria

Purpose:

| | Culling | Robotics | Research |
|---|---|---|---|
| General | Study | Study | Study |
| Information | Name? | Name? | Name? |
| Criteria: | Material | Technician? | Material |
| | Type? | | Type? |
| | Custodian? | | Custodian? |

In some embodiments, the evaluation application 36 captures study information utilizing study criteria. Study criteria may relate to specifics about a study, collection, and/or at least one specimen, including data relating to the viability of at least one specimen in the collection as well as data relating to the collection of information associated with the collection. In one embodiment, Table 2 indicates at least some study criteria that may be utilized by the evaluation application 36.

TABLE 2
Study Criteria

Purpose:

| | Culling | Robotics | Research |
|---|---|---|---|
| Study Criteria: | Historical or | Freezer | Number of |
| | unique | name. | specimens |
| | disease | | meeting |
| | prevalence? | | material type |
| | (Y/N) | | criteria. |
| | Prospective | Rack | Prospective |
| | or | | or |
| | retrospective | | retrospective |
| | collection? | | collection? |
| | Size of a | Box | Size of a |
| | sample | | sample |
| | population? | | population? |
| | Is the study | | Are quality |
| | complete? | | control |
| | | | specimens |
| | | | available? |
| | In what | | Is study for |
| | format is a | | which |
| | pathology | | specimens |
| | report | | were |
| | available? | | collected |
| | | | complete? |
| | Has | | Date of death |
| | diagnosis in | | known? |
| | pathology | | |
| | report been | | |
| | confirmed? | | |
| | Digital | | Age of donor |
| | images | | known? |
| | captured and | | |
| | stored? | | |
| | | | Cost of |
| | | | specimen |
| | | | acquisition. |

In some embodiments, the evaluation application 36 captures specimen information associated with at least one specimen utilizing specimen criteria. The specimen criteria may relate to the specimen, such as container types used to store the specimen and the volumes of specimen stored. In one embodiment, Table 3 indicates at least some specimen criteria that may be utilized by the evaluation application 36.

TABLE 3
Specimen Criteria

Purpose:

| | Culling | Robotics | Research |
|---|---|---|---|
| Specimen | Size of | Select type | How many |
| Criteria: | specimen | of label. | aliquots are |
| | available? | | available? |
| | Size of | Select type | What size |
| | specimen. | of identifier. | aliquots are |
| | | | available? |
| | How many | Is label | Suitability for |
| | aliquots are | secure? | anticipated |
| | available? | | testing |
| | | | platform? |
| | What size | Select vial | |
| | aliquots are | type. | |
| | available? | | |
| | Date | Select cap | |
| | collected | type. | |
| | known? | | |
| | Time to | Is cap wider | |
| | fixation. | than vial? | |
| | | Is vial | |
| | | covered in | |
| | | foil? | |
| | | Does | |
| | | specimen | |
| | | appear | |
| | | desiccated? | |

In some embodiments, the evaluation application 36 captures annotation information associated with at least one specimen utilizing annotation criteria. The annotation criteria may relate to information about the data collected as part of the protocol, or purpose for, a particular study. In one embodiment, Table 4 indicates at least some annotation criteria that may be utilized by the evaluation application 36.

TABLE 4
Annotation Criteria

Purpose:

| | Culling | Robotics | Research |
|---|---|---|---|
| Annotation | Unique | Hand written | Unique |
| Criteria: | patient ID | labeling | patient ID |
| | | requiring | |
| | | preservation? | |
| | | (Y/N) | |
| | Gender | Relabeling | Gender |
| | | required? | |
| | | (Y/N) | |
| | Race | | Race |
| | Neoadjuvant | | Neoadjuvant |
| | therapy | | therapy |
| | started prior | | started prior |
| | to resection? | | to resection? |
| | (Y/N) | | (Y/N) |
| | Date of | | Date of |
| | original | | original |
| | pathology | | pathology |
| | diagnosis. | | diagnosis. |
| | Tumor stage. | | Tumor stage. |
| | Date of | | Date of |
| | death. | | death. |
| | Age | | Age |
| | Select warm | | Select warm |
| | ischemia | | ischemia |
| | time. | | time. |
| | Select how | | Select how |
| | the specimen | | the specimen |
| | was | | was |
| | preserved. | | preserved. |
| | Are | | Are |
| | associated | | associated |
| | normal | | normal |
| | specimens | | specimens |
| | available? | | available? |
| | (Y/N) | | (Y/N) |

In some embodiments, the evaluation application 36 captures storage and handling information associated with at least one specimen utilizing storage and handling criteria. The storage and handling criteria may relate to the harvest of, processing of, and the storage and handling of specimens. In one embodiment, Table 5 indicates at least some storage and handling criteria that may be utilized by the evaluation application 36 to capture data.

TABLE 5
Storage and Handling Criteria

Purpose:

| | Culling | Robotics | Research |
|---|---|---|---|
| Storage and | Select | Row | Select cost to |
| Handling | access | location? | pull and ship |
| Criteria: | activity rate. | | specimens. |
| | Select | Column | Select |
| | percent that | location? | percent that |
| | has been | | has been |
| | thawed and | | thawed and |
| | returned to | | returned to |
| | inventory. | | inventory. |
| | Select label | Is row | |
| | type. | accurate? | |
| | If barcoded, | Is column | |
| | select | accurate? | |
| | percent of | | |
| | specimens | | |
| | found to be | | |
| | readable by | | |
| | scanner. | | |
| | Labels | Select box | |
| | secure? | grid | |
| | (Y/N) | configuration. | |
| | Select | Select | |
| | container | number of | |
| | type. | vials in grid. | |
| | Select | Select | |
| | storage | number of | |
| | temperature. | times sample | |
| | | thawed. | |
| | | Vial | |
| | | damaged? | |
| | | Vial cap | |
| | | above grid? | |
| | | Can vial be | |
| | | removed | |
| | | without | |
| | | damage to | |
| | | label? | |

In some embodiments, the evaluation application 36 captures legal and regulatory information associated with at least one specimen utilizing legal and regulatory criteria. The legal and regulatory criteria may relate to legal and regulatory issues surrounding specimens, as well as specifics about transfer agreements, consent, privacy, and security data. In one embodiment, Table 6 indicates at least some legal and regulatory criteria that may be utilized by the evaluation application 36.

TABLE 6
Legal and Regulatory Criteria

Purpose:

| | Culling | Robotics | Research |
|---|---|---|---|
| Legal and | Consent? | Regulated | Consent? |
| Regulatory | Date of | handling for | Date of |
| Criteria: | Consent | security or | Consent |
| | documented | safety? (Y/N) | documented |
| | or available? | | or available? |
| | Consent | | Consent |
| | forms | | forms |
| | available for | | available for |
| | review? | | review? |
| | (Y/N) | | (Y/N) |
| | Curator with | | Curator with |
| | historical | | historical |
| | knowledge | | knowledge |
| | available? | | available? |
| | (Y/N) | | (Y/N) |
| | Labels | | Labels |
| | contain | | contain |
| | individually | | individually |
| | identifiable | | identifiable |
| | personal | | personal |
| | information? | | information? |
| | (Y/N) | | (Y/N) |
| | Material | | Material |
| | transfer | | transfer |
| | agreements | | agreements |
| | exist? (Y/N) | | exist? (Y/N) |
| | Material is | | Material is |
| | hazardous? | | hazardous? |
| | (Y/N) | | (Y/N) |
| | Select status | | Select status |
| | of IRB | | of IRB |
| | approval | | approval |

Although specific criteria are indicated in Tables 1-6, alternative embodiments of the evaluation application 36 may utilize more, fewer, or different criteria. Thus, one having ordinary skill in the art will appreciate that additional and/or alternative criteria can be utilized without departing from embodiments of the invention.

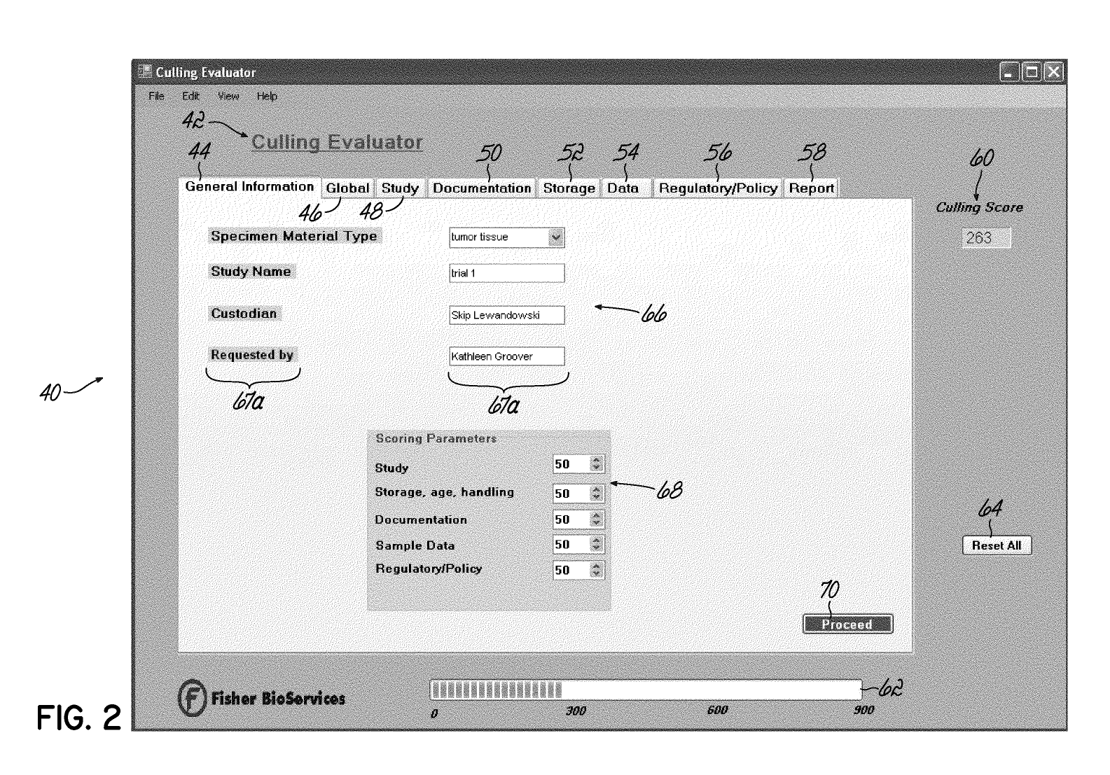

In some embodiments, the evaluation application 36 provides the criteria and captures data associated therewith utilizing a plurality screens. Consistent with embodiments of the invention, FIGS. 2-9 illustrate a plurality of screens that may be provided by the evaluation application 36 for display on the computing system 10 and/or another computing system (e.g., such as computing system 18 or server 22) to receive data associated with a collection and/or at least one specimen, then evaluate that data. Specifically, FIG. 2 is a general information screen 40 that indicates the purpose for the evaluation chosen by the user as at 42 (e.g., as illustrated, for culling purposes) as well as several tabs that the user can select to view criteria and input data associated therewith. Specifically, the general information screen 40 illustrates a general information tab 44, a global tab 46, a study tab 48, a documentation tab 50, a storage tab 52, a data tab 54, a legal and regulatory tab 56 (e.g., illustrated as “Regulatory/Policy” tab 56), and a report tab 58. The general information screen 40 also illustrates a current numeric score for the evaluation as at 60 and a more general view of the score along a line bar indicator as at 62. The general information screen 40 also includes a “Reset All” button 64 to reset all values of criteria previously entered.

The general information screen 40 is provided in response to the user selecting the general information tab 44 and/or after the user has selected a purpose for the evaluation. In turn, the general information screen 40 provides at least some general information criteria as at 66. As illustrated, each general information criteria, and indeed all criteria, include text associated with the criteria (e.g., the text of the criteria, such as “Study Name”) (shown in general as at 67A) as well as a user interface element in which to enter or specify data associated with the criteria (e.g., such as a drop-down box, a check box, a text entry box, a numerical selector, and/or other user interface element) (shown in general as at 67B).

In addition to providing general information criteria 66, the general information screen 40 includes a scoring parameters component 68 that allows the user to adjust scoring parameters for categories. The scoring parameters, in some embodiments, weight the criteria associated with specific categories. For example, for culling, a user may assign more weight to the storage and handling criteria than they do to the regulatory and legal criteria. Thus, the user may adjust the scoring for storage and handling criteria to be higher than criteria for at least one other category. As such, the scoring parameters component 68 allows the user to assign variables, or “weights,” to specific categories. The global information screen 40 further illustrates that the user proceeds to view a screen associate with the next tab by selecting a “Proceed” button 70.

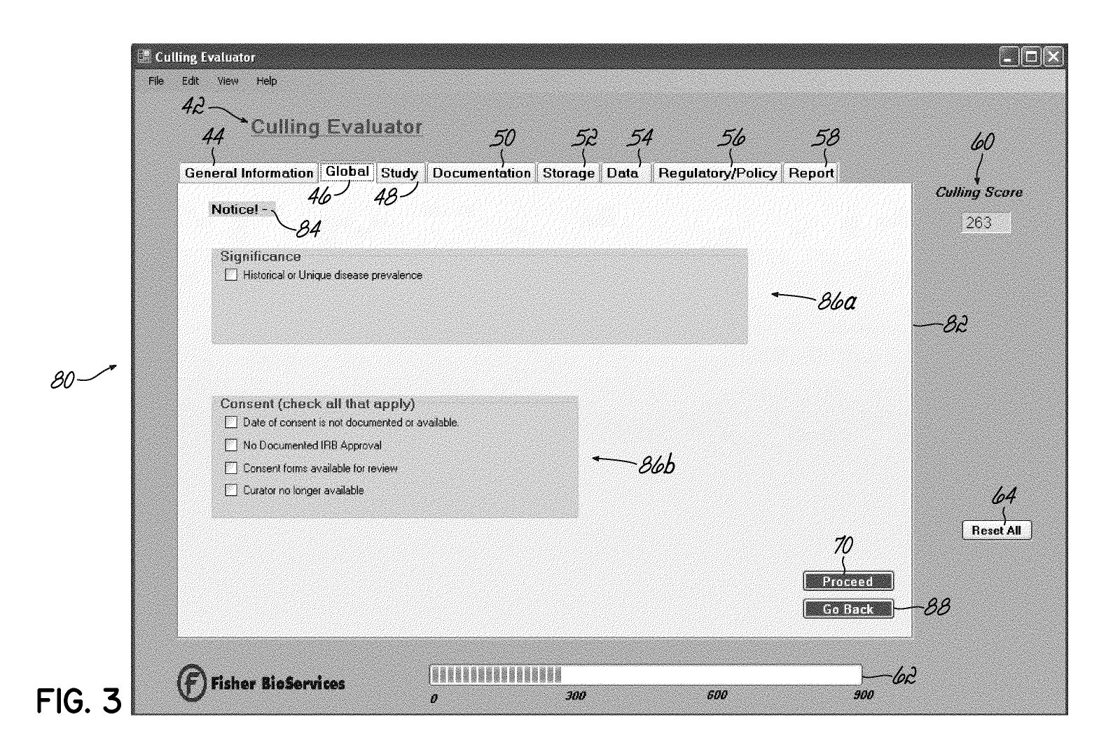

FIG. 3 is an illustration of a global screen 80 provided in response to the user selecting the global tab 46 or navigating to the global screen 80 from a previous screen. The global screen 80 provides at least some study criteria as at 82. Specifically, and as illustrated in FIG. 3, the global screen 80 includes a notice 84 that provides instructions to the user, if necessary. Moreover, the global screen 80 provides a significance frame 86A that includes study criteria related to the significance of at least one specimen as well as a consent frame 86B that includes study criteria related to the consent obtained with respect to at least one specimen. In addition, the global data screen 80 illustrates a “Go Back” button 88 that the user may select to return to a previous screen.

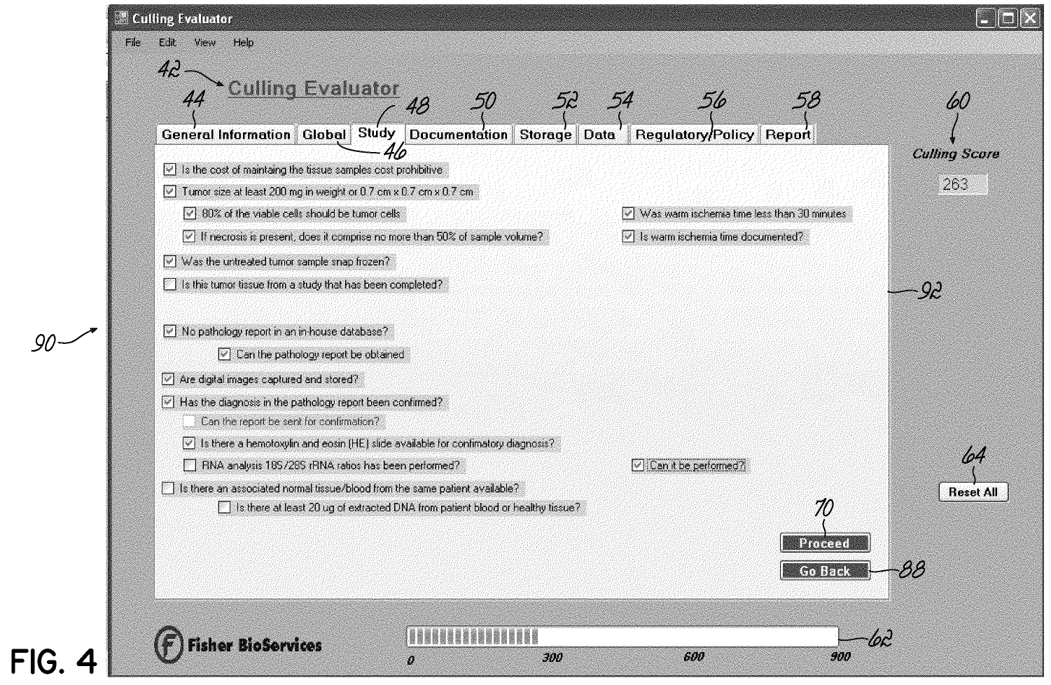

FIG. 4 is an illustration of a study screen 90 provided in response to the user selecting the study tab 48 or navigating to the study screen 90 from a previous screen. The study screen 90 provides at least some specimen criteria as at 92.

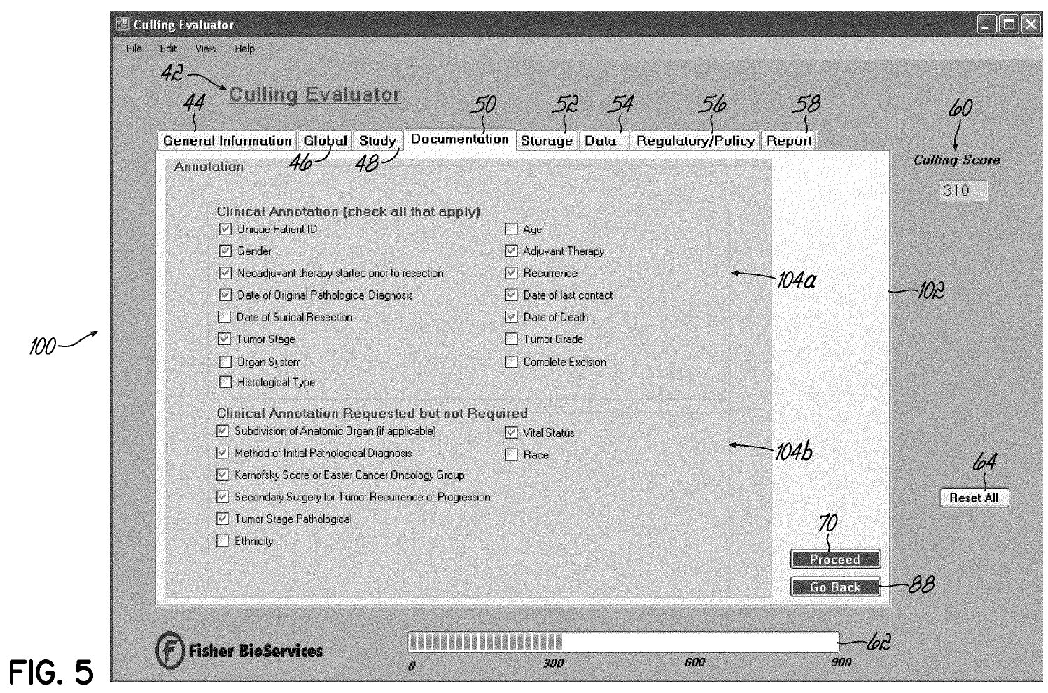

FIG. 5 is an illustration of a documentation screen 100 provided in response to the user selecting the documentation tab 50 or navigating to the documentation screen 100 from a previous screen. The documentation screen 100 provides at least some annotation criteria as at 102. Specifically, and as illustrated in FIG. 5, the documentation screen 100 provides a clinical annotation frame 104A that includes annotation criteria associated with data gathered or known about the source of the specimen, as well as an optional clinical annotation frame 104B that includes annotation criteria associated with data that was requested regarding the source of the specimen but that was optional. For example, the clinical annotation frame 104A may include an annotation criteria associated with data that is known about at least one specimen. Specifically, the “Unique Patient ID” criteria in the clinical annotation frame 104A may be checked when the at least one specimen is associated with a unique patient ID of a respective patient. Conversely, the “Age” criteria in the clinical annotation frame 104A may not be checked when the at least one specimen is not associated with an age of a respective patient. Similarly, the optional clinical annotation frame 104B may query the user regarding data that was requested, but not required, upon acquisition of the at least one specimen. Specifically, the “Ethnicity” criteria in the optional clinical annotation frame 104B may not be checked when the ethnicity associated with a patient was not noted during the acquisition of a specimen.

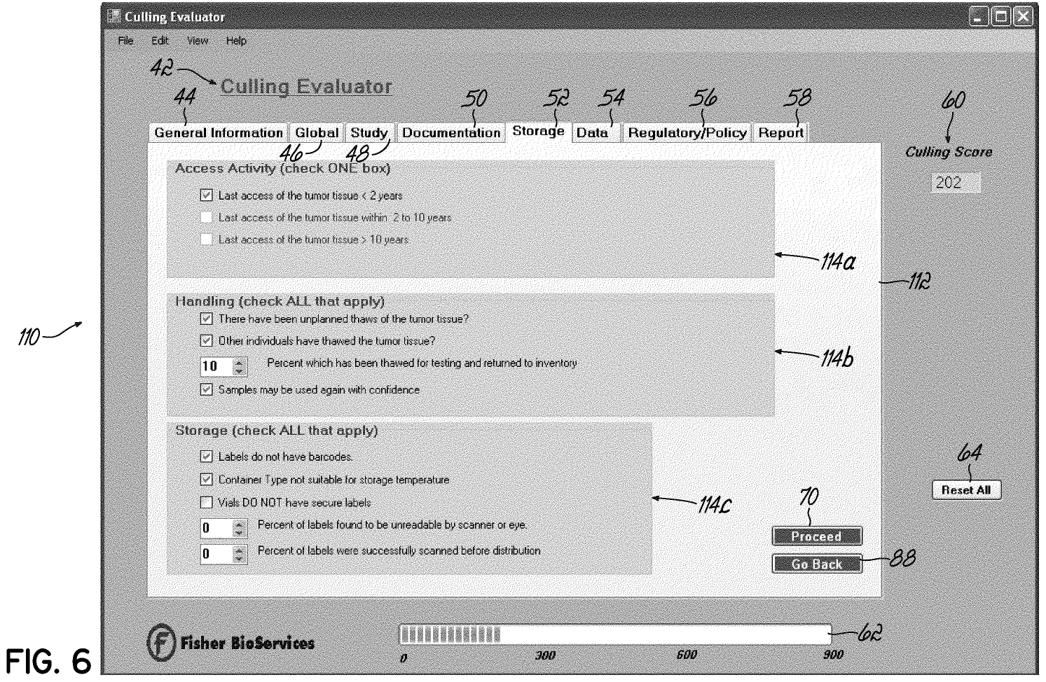

FIG. 6 is an illustration of a storage screen 110 provided in response to the user selecting the storage tab 52 or navigating to the storage screen 110 from a previous screen. The storage screen 110 provides at least some storage and handling criteria as at 112. Specifically, and as illustrated in FIG. 6, the storage screen 110 provides an access activity frame 114A that includes storage and handling criteria associated with access to at least one specimen, a handling frame 1148 that includes storage and handling criteria associated with the handling of at least one specimen, as well as a storage frame 114C that includes storage and handling criteria associated with the storage of at least one specimen.

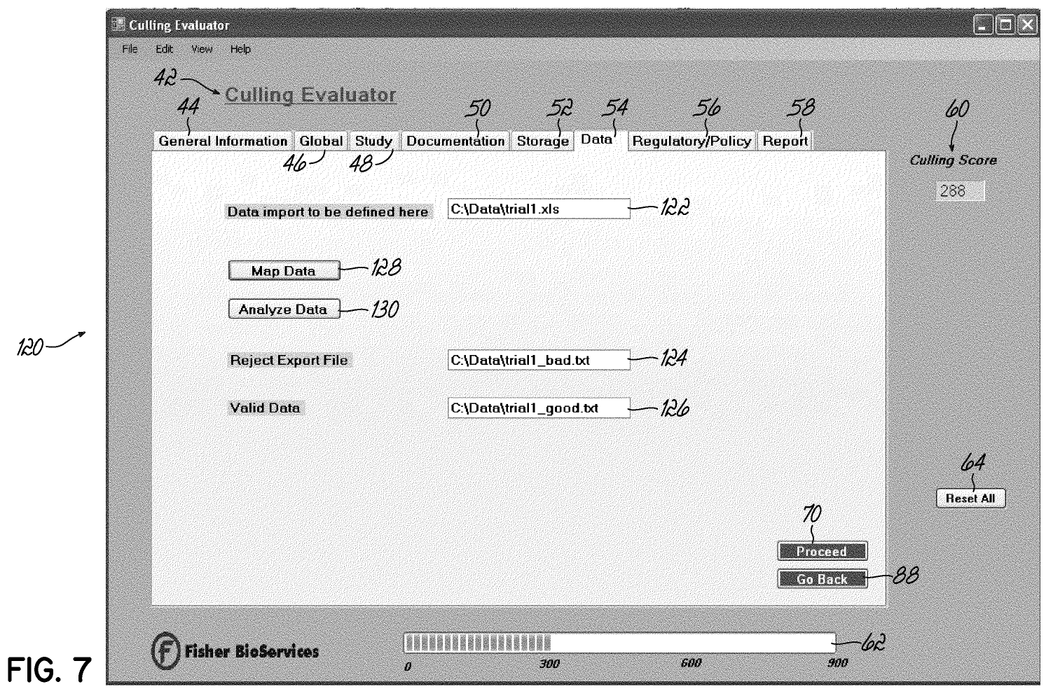

FIG. 7 is an illustration of a data file screen 120 provided in response to the user selecting the data tab 54 or navigating to the data file screen 120 from a previous screen. The data file screen 120 provides the user with an interface to upload or otherwise specify a data file that includes criteria data that can be used in an evaluation. For example, a user may input data for at least one specimen into a data file, such as a spreadsheet format data file, and in particular a Microsoft® Office Excel® file as developed by Microsoft Corporation of Redmond, Wash. As such, the user may load the data file for use by the evaluation application 36.

The data file screen 120 includes a data import control 122 for the user to specify the location of a data file, a rejected record control 124 for the user to specify the location to store rejected records of the specified data file, as well as a valid data control 126 for the user to specify the location to store valid records of the specified data file. The data file screen 120 additionally includes a “Map Data” button 128 the user selects to map data in the specified data file to criteria as discussed below, as well as an “Analyze Data” button 128 the user selects to analyze and validate a specified data record as also discussed below.

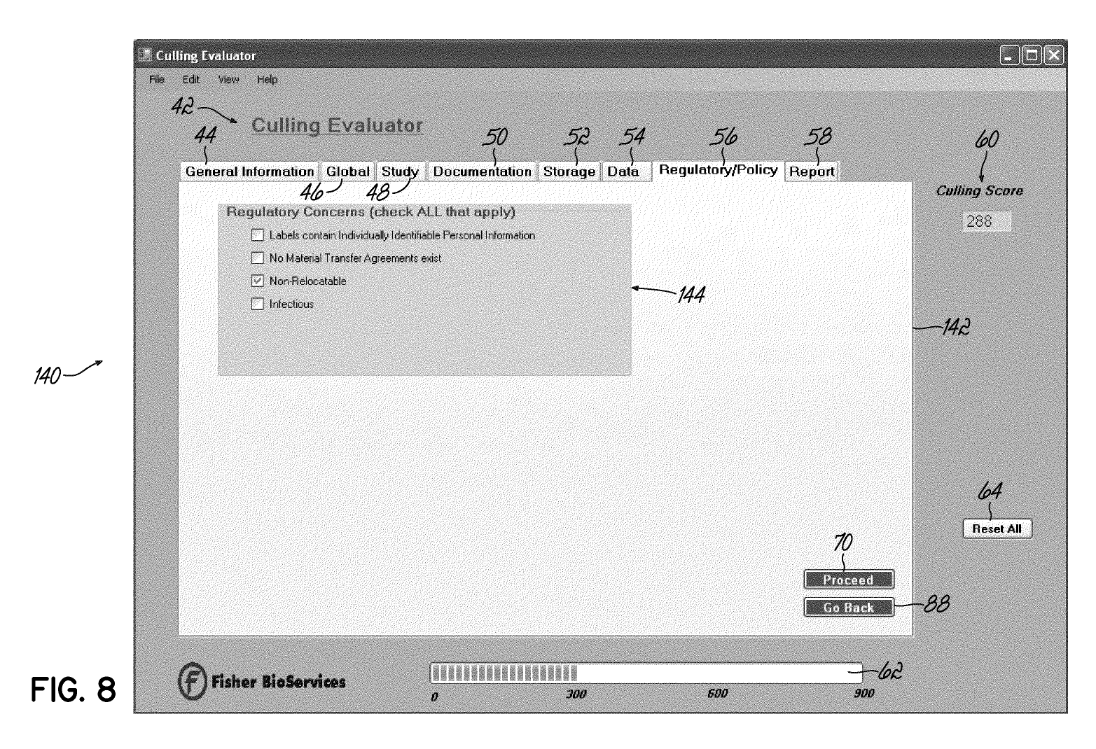

FIG. 8 is an illustration of a legal and regulatory screen 140 provided in response to the user selecting the legal and regulatory tab 52 or navigating to the legal and regulatory screen 140 from a previous screen. The legal and regulatory screen 140 provides at least some legal and regulatory criteria as at 142. Specifically, and as illustrated in FIG. 6, the legal and regulatory screen 140 provides a regulatory frame 144 that includes legal and regulatory criteria associated with regulatory concerns raised by the at least one specimen.

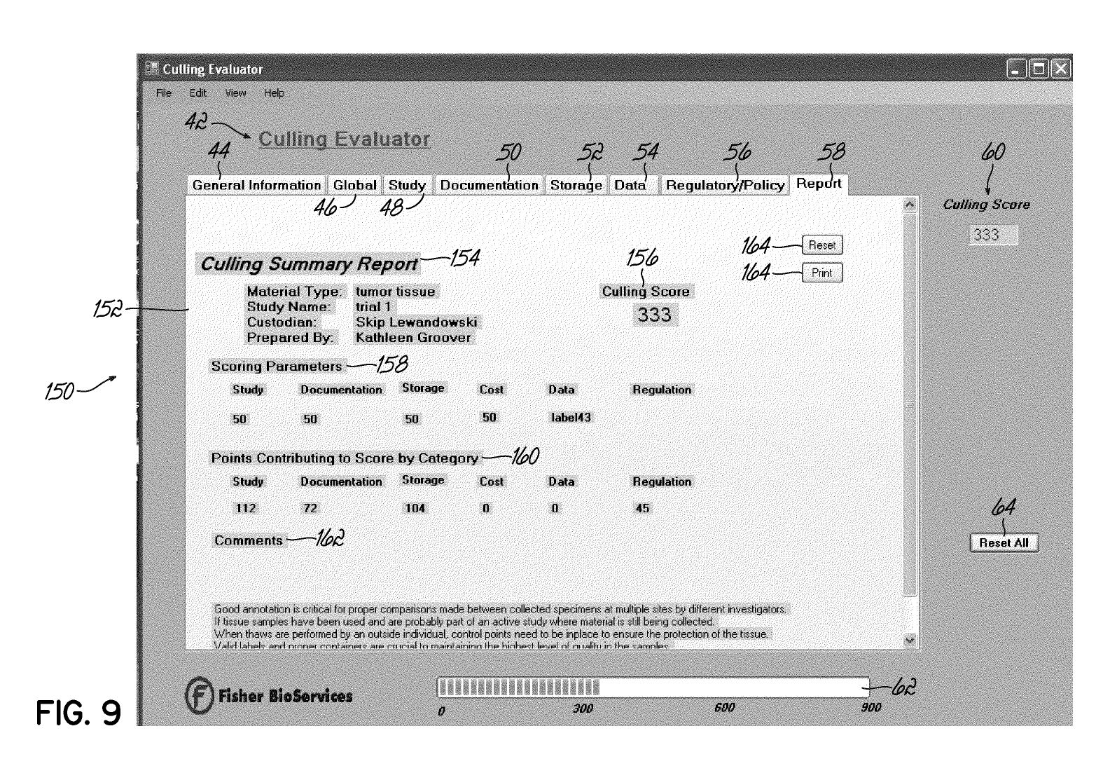

FIG. 9 is an illustration of a report screen 150 provided in response to the user selecting the report tab 58 or navigating to the report screen 150 from a previous screen. The report screen 150 includes a report 152 that is generated based on the data captured by the evaluation application 36 or uploaded to the evaluation application 36. In particular, the report 152 includes a summary section 154 that indicates the evaluation score as at 156, as well as a scoring parameters section 158 that indicates the scoring parameters specified for each category. Moreover, the report breaks down the contribution of points in each category to the total evaluation score 60 and 156 in a points contribution section 160. Finally, the report includes a comments section 162 that provides comments about the score, evaluation, categories, and/or criteria. The user resets the data used by the evaluation application 36 by selecting the “Reset” button 164 and prints the report 152 on a printing device (not shown) coupled to the computing system 10 by selecting the “Print” button 166.

In some embodiments, the data associated with each criteria (e.g., the user input data captured by the evaluation application 36) is assigned a numeric value. For example, a checked checkbox may be assigned a numeric value of ten, while an unchecked checkbox is assigned a numeric value of zero. Also for example, the data in a numeric input box (e.g., such as one that specifies the percentage of a collection that has been thawed as illustrated in FIG. 6) may be assigned a numeric value that corresponds to the value entered. Specifically, the data in the numeric input box may be multiplied or divided by a particular constant before it is weighted by a scoring parameter. Thus, and also for example, a value of ten in the numeric input box may be assigned a value of one-hundred, or, alternatively, a value of ten in the numeric input box may be assigned a value of five. In any event, the evaluation application 36 multiplies criteria by a scoring parameter associated with their category then sums the resultant values to determine the score.

A person having ordinary skill in the art will appreciate that the environments illustrated throughout FIGS. 1-9 are not intended to limit the scope of embodiments of the invention. More or fewer categories. In particular, the computing system 10 may include fewer or additional components consistent with alternative embodiments of the invention. Indeed, a person having skill in the art will recognize that other alternative hardware, software, and/or user interface environments may be used without departing from the scope of the invention. For example, the evaluation application 36 may provide more or fewer screens and/or more or fewer criteria than those illustrated and described. Additionally, a person having ordinary skill in the art will appreciate that the computing system 10 may include more or fewer applications. As such, other alternative hardware and software environments may be used without departing from the scope of embodiments of the invention.

The routines executed to implement the embodiments of the invention, whether implemented as part of an operating system or a specific application, component, program, object, module, or sequence of operations, instructions, or steps executed by one or more microprocessors, controller, or computing system will be referred to herein as a “sequence of operations,” a “program product,” or, more simply, “program code.” The program code typically comprises one or more instructions that are resident at various times in various memory and storage devices, and that, when read and executed by one or more processors, cause a computing system to perform the steps necessary to execute steps, elements, and/or blocks embodying the various aspects of the invention.

While the invention has and hereinafter will be described in the context of fully functioning computing systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to physical and tangible recordable type media such as volatile and nonvolatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

### Software Description and Flows

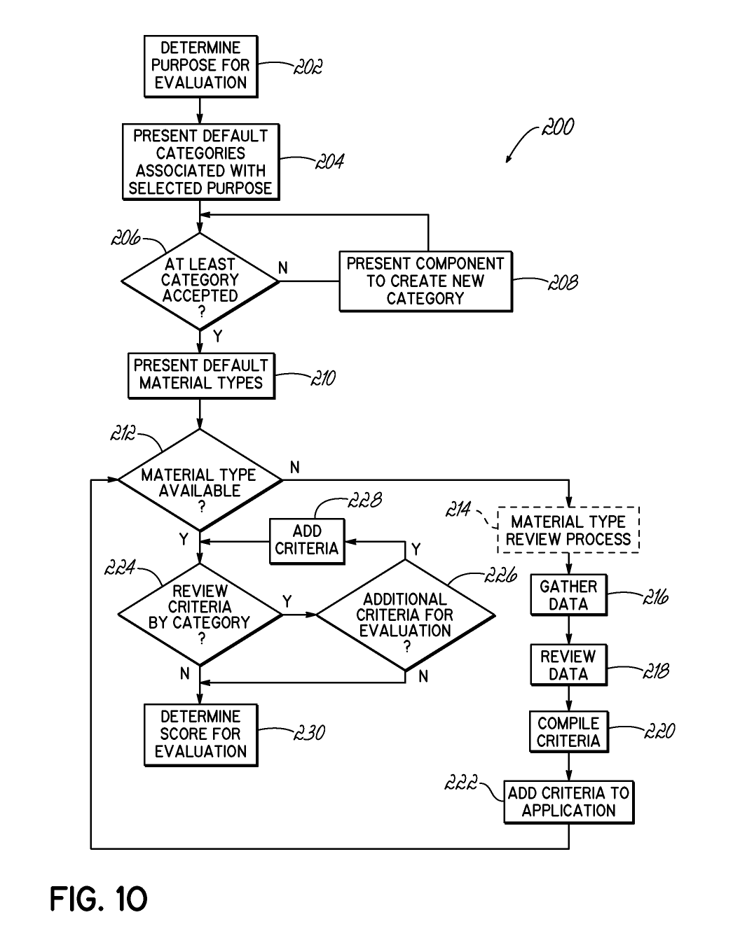

FIG. 10 is a flowchart 200 illustrating a sequence of operations to select and configure an evaluation utilizing an evaluation application. In particular, the evaluation application determines a purpose for the evaluation (e.g., such as based on user input that specifies the evaluation is for culling, transport, and/or robotics, to name a few) (block 202) and presents default categories associated with the selected purpose (block 204). As discussed above, these categories can include a general information category, a study category, a specimen category, an annotation category, a storage and handling category, a legal and regulatory category, a user generated category (e.g., a custom category created by the user) and/or additional categories. Thus, the evaluation application establishes whether the user has chosen at least one category to include in the evaluation (block 206). When at least one category has not been chosen (“No” branch of decision block 206) the evaluation application provides the user with a component to create at least one new category (block 208) and again establishes whether at least one category has been chosen (block 206).

When at least one category has been chosen to include in the evaluation (“Yes” branch of decision block 206), the evaluation application presents default material types associated with the chosen categories (block 210) and determines whether the user chooses an available material type (block 212). When the user chooses an unavailable material type (“No” branch of decision block 212) the evaluation application accepts material type information after a material type review process (block 214) in which the user gathers data associated with the material type (block 216), reviews that data (block 218), compiles criteria for the material type (block 220) and adds those criteria to the evaluation application and in particular to a category thereof (block 222).

Thus, when the user chooses an available material type (“Yes” branch of decision block 212) the evaluation application determines whether the user chooses to review criteria for the material type, and thus the evaluation, by category (block 224). When the user chooses to review the criteria by category (“Yes” branch of decision block 224) the evaluation application determines whether the user selects to add criteria for evaluation (block 226). When the user chooses to add criteria to the evaluation (“Yes” branch of decision block 226) the evaluation application provides the user with a component to create and add new criteria to a category (block 228), then again determines whether the user chooses to review the criteria by category (block 224). When the user does not choose to review the criteria by category (“No” branch of decision block 224) or when the user does not choose to add criteria to the evaluation (“No” branch of decision block 226) the evaluation determines a score for the evaluation (block 230)

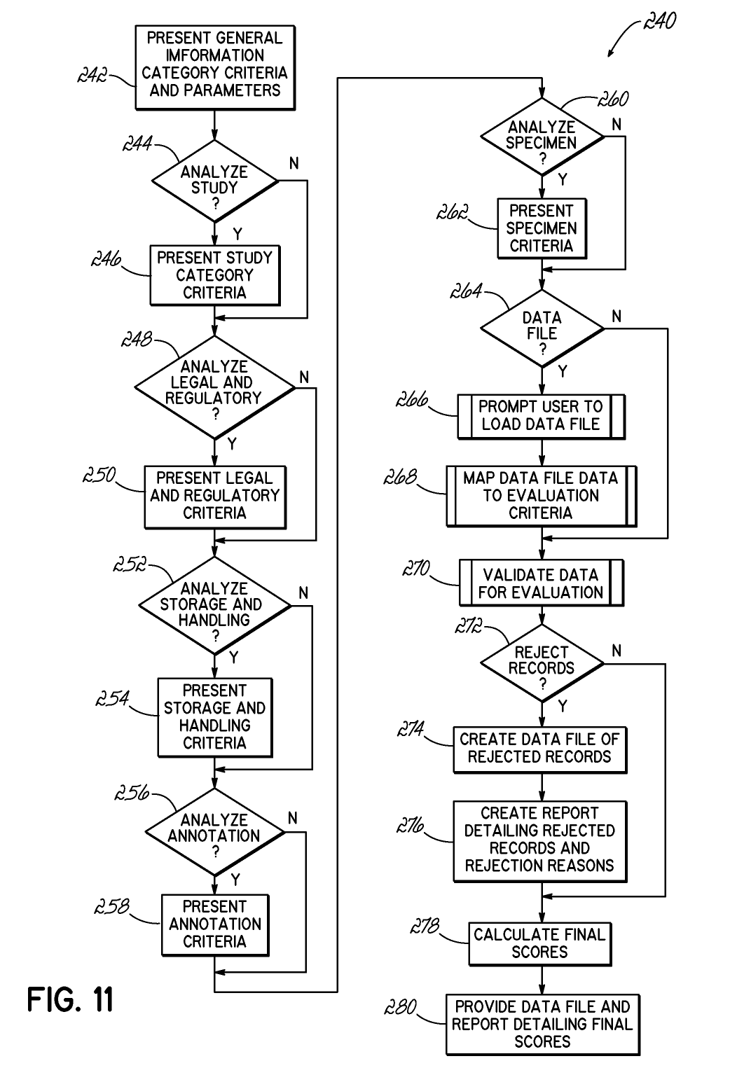

FIG. 11 is a flowchart 240 illustrating a sequence of operations to determine a score for an evaluation. Specifically, the evaluation application presents general information category criteria and parameters (block 242). The general information category criteria and parameters provide the user with general information category criteria and also allow the user to select a value from 0 to 100 for each category that, in turn, weighs those categories according to their importance. For example, if the study category for a particular evaluation is the most important category, the general information parameters allow the user to rate the study category higher than any other category such that the evaluation application will weight criteria associated with the study category more than criteria associated with other categories. The general information category criteria, in turn, can include criteria related to the methods used to collect a specific collection, the population of a specific collection, and/or the scope of a specific collection. After the general information criteria and parameters have been provided and/or configured (block 242), the evaluation application may begin analysis of selected categories.

In particular, the evaluation application determines whether the user has chosen to include the study category (block 244). When the user has chosen the study category to be analyzed in the evaluation (“Yes” branch of decision bock 244), the evaluation application presents study category criteria (block 246). In particular, study category criteria allow the evaluation application to capture data relating to the methods, populations, and scope of a collection of specimens, as well as the cost of the study, funding for the study, and other study information. The study category criteria may include one or more of the study category criteria discussed above.

After determining that the user has not chosen to include the study category (“No” branch of decision block 244) or after presenting the study category criteria (block 246), the evaluation application determines whether the user has chosen to include the legal and regulatory category (block 248). When the user has chosen the legal and regulatory category to be analyzed in the evaluation (“Yes” branch of decision bock 248), the evaluation application presents legal and regulatory category criteria (block 250). In particular, legal and regulatory category criteria allow the evaluation application to capture data relating to legal and regulatory issues surrounding specimens, as well as specifics about transfer agreements, consent, privacy, and security data. The legal and regulatory category criteria may include one or more of the legal and regulatory category criteria discussed above.

After determining that the user has not chosen to include the legal and regulatory category (“No” branch of decision block 248) or after presenting the legal and regulatory category criteria (block 250), the evaluation application determines whether the use has chosen to include the storage and handling category (block 252). When the user has chosen the storage and handling category to be analyzed in the evaluation (“Yes” branch of decision bock 252), the evaluation application presents storage and handling category criteria (block 254). In particular, storage and handling category criteria allow the evaluation application to capture data relating to the harvest of, processing of, and the storage and handling of specimens, and may include one or more of the storage and handling category criteria discussed above.

After determining that the user has not chosen to include the storage and handling category (“No” branch of decision block 252) or after presenting the storage and handling category criteria (block 254), the evaluation application determines whether the use has chosen to include the annotation category (block 256). When the user has chosen the annotation category to be analyzed in the evaluation (“Yes” branch of decision bock 256), the evaluation application presents annotation category criteria (block 258). In particular, annotation category criteria allow the evaluation application to capture data collected as part of the protocol, or purpose for, a particular study. Some annotation category criteria may be required, while others may be optional. Annotation category criteria may include one or more of the annotation category criteria discussed above.

After determining that the user has not chosen to include the annotation category (“No” branch of decision block 256) or after presenting the annotation category criteria (block 258), the evaluation application determines whether the use has chosen to include the specimen category (block 260). When the user has chosen the specimen category to be analyzed in the evaluation (“Yes” branch of decision bock 260), the evaluation application presents specimen category criteria (block 258). In particular, specimen category criteria allow the evaluation application to capture data relating to the specimen, such as container types used and the volumes stored. The specimen category criteria may include one or more of the specimen category criteria discussed above.

After determining that the user has not chosen to include the specimen category (“No” branch of decision block 260) or after presenting the specimen category criteria (block 262), the evaluation application may determine whether the user has chosen to include at least one custom category (decision block not shown) similarly to the determinations in blocks 244, 248, 252, 256, and 260. In the event the user has chosen to include at least one custom category, the evaluation application may provide criteria associated with that custom category (block not shown). Alternatively, after determining that the user has not chosen to include the specimen category (“No” branch of decision block 260) or after presenting the specimen category criteria (block 262), or, further alternatively, after determining that the user has not chosen to include a custom category, the evaluation application determines if a user has chosen to load a data file with data for the evaluation (block 264). For example, the user may load a data file that is generated from another entity, such as another user or laboratory that previously generated an evaluation. Thus, when the user has chosen to load a data file with data for the evaluation (“Yes” branch of decision block 264) the evaluation application prompts the user to load that data file (block 266). Upon receipt of the data file, the user may prompt map data in the data file to evaluation criteria (block 268). For example, the data file for an evaluation may have originated from another user or laboratory. As such, the data file for the evaluation may have been generated from a first evaluation that was for a different purpose than the current, or second, evaluation. Specifically, the first evaluation may have been used for a culling purpose while the second evaluation is for a research use purpose. Thus, the user may map data for the criteria of first evaluation, such as the study name or a unique ID for a particular specimen, to corresponding criteria of the second evaluation in block 268.

After determining that the user has not chosen to load a data file (“No” branch of decision block 264) or after to the user maps the data file data to evaluation criteria (block 268), the evaluation application validates the data for the evaluation (e.g., data that was captured in response to criteria or provided in a data file) (block 270). For example, in a particular evaluation, the name of a specimen may be required, while in another evaluation that name is not required. As such, the evaluation application may validate that required data is captured by determining from data associated with the evaluation what data is required, determining from the captured/loaded data whether all required data has been captured, and then prompting the user with criteria associated with missing required data when there is missing required data. Also for example, the evaluation application may validate that captured/loaded data is valid. As such, the evaluation application may validate that numerical data only includes numbers, that Yes/No or T/F data only includes a binary choice, and that string data does not include unauthorized or otherwise illegal characters.

When validating data for the evaluation (block 270), the evaluation application may reject any records that are not associated with data, invalid, and/or that otherwise fail validation (block 272). Alternatively, as discussed above, the evaluation application may prompt the user for missing data such that all records are complete after validation. In any event, when at least one record is rejected (“Yes” branch of decision block 272) the evaluation application creates a data file that includes the rejected records (block 274) and creates a report detailing the rejected records as well as the reason for the rejection (e.g., a “rejection report”) (block 276). After determining that at least one record has not been rejected (“No” branch of decision block 272) or after creating a rejection report (block 276) the evaluation application calculates final scores for at least one specimen based on data associated with criteria and weights assigned thereto (block 278), then provides a data file and report detailing that final score (block 280).

While the present invention has been illustrated by a description of the various embodiments, and while these embodiments have been described in considerable detail, it is not the intention of the applicant to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described.

In particular, a person having ordinary skill in the art will appreciate that additional purposes, criteria, screens, and user interface elements may be used without departing from the scope of the invention. Moreover, a person having ordinary skill in the art will appreciate that any of the blocks of the above flowcharts may be deleted, augmented, made to be simultaneous with another, combined, or be otherwise altered in accordance with the principles of the embodiments of the invention. Still further, a person having ordinary skill in the art will appreciate that any of the screens illustrated throughout FIGS. 2-9 may be illustrated on that separate computing system. Accordingly, departures may be made from such details without departing from the spirit or scope of applicants' general inventive concept.

What is claimed is:

1. A method of evaluating at least one specimen for a predetermined purpose with a computing system, the method comprising:
establishing at least one category that includes a plurality of criteria with which to evaluate the at least one specimen;
receiving at least one scoring parameter that weights the at least one category;
presenting at least some of the plurality of criteria to the user; and
calculating, based upon the scoring parameter as well as data entered by the user and associated with the presented criteria, a score for the at least one specimen.

2. The method of claim 1, further comprising:
providing a user interface for the user to specify the predetermined purpose.

3. The method of claim 2, wherein the predetermined purpose includes a purpose selected from the group consisting of a culling purpose, a robotics purpose, a research purpose, a quality rating purpose, and combinations thereof.

4. The method of claim 2, wherein the predetermined purpose establishes each category to utilize to evaluate the at least one specimen.

5. The method of claim 1, wherein establishing at least one category with which to evaluate the at least one specimen includes:
providing a user interface for the user to specify the at least one category.

6. The method of claim 5, wherein the category includes a category selected from the group consisting of a general information category, a study category, a legal and regulatory category, a storage and handling category, an annotation category, a specimen category, a user generated category, and combinations thereof.

7. The method of claim 1, wherein presenting at least some of the plurality of criteria to the user further comprises:
associating each of the presented criteria with a user interface element to receive data from the user; and
assigning each of the presented criteria with a numerical value based on the data entered into the user interface element.

8. The method of claim 1, further comprising:
receiving a data file from the user that includes a plurality of records; and
providing a user interface to the user to map at least one record to at least one of the plurality of criteria.

9. The method of claim 1, further comprising:
generating a report that indicates the calculated score, information regarding each category used to evaluate the at least one specimen, and scoring parameters for each category.

10. The method of claim 1, further comprising:
receiving data associated with each presented criteria.

11. The method of claim 10, wherein calculating the score includes
assigning numeric values to the data associated with each presented criteria;
multiplying each numeric value with the scoring parameter to produce respective products; and
summing the products.

12. An apparatus, comprising:
at least one processing unit; and
a memory containing program code, the program code configured to, when executed by the at least one processing unit, establishes at least one category that includes a plurality of criteria with which to evaluate at least one specimen, receive at least one scoring parameter that weights the at least one category, present at least some of the plurality of criteria to the user, and calculate, based upon the scoring parameter as well as data entered by the user and associated with the presented criteria, a score for the at least one specimen.

13. The apparatus of claim 12, wherein the program code is further configured to provide a user interface for the user to specify a predetermined purpose for the evaluation.

14. The apparatus of claim 13, wherein the predetermined purpose includes a purpose selected from the group consisting of a culling purpose, a robotics purpose, a research purpose, a quality rating purpose, and combinations thereof.

15. The apparatus of claim 13, wherein the predetermined purpose establishes each category to utilize to evaluate the at least one specimen.

16. The apparatus of claim 12, wherein the program code is further configured to provide a user interface for the user to specify the at least one category.

17. The apparatus of claim 16, wherein the category includes a category selected from the group consisting of a general information category, a study category, a legal and regulatory category, a storage and handling category, an annotation category, a specimen category, a user generated category, and combinations thereof.

18. The apparatus of claim 12, wherein the program code is further configured to associate each of the presented criteria with a user interface element to receive data from the user, and assign each of the presented criteria with a numerical value based on the data entered into the user interface element.

19. The apparatus of claim 12, wherein the program code is further configured to receive a data file from the user that includes a plurality of records and provide a user interface to the user to map at least one record to at least one of the plurality of criteria.

20. The apparatus of claim 11, wherein the program code is further configured to generate a report that indicates the calculated score, information regarding each category used to evaluate the at least one specimen, and scoring parameters for each category.

21. The apparatus of claim 12, wherein the program code is further configured to receive data associated with each presented criteria.

22. The apparatus of claim 21, wherein the program code is further configured to assign numeric values to the data associated with each presented criteria, multiply each numeric value with the scoring parameter to produce respective products, and sum the products.
